(19) United States
(12) Patent Application Publication
(10) Pub. No.: US 2002/0198739 A1
(43) Pub. Date: Dec. 26, 2002

(54) Matching and mapping clinical data to a standard

(76) Inventors: Lee Min Lau, Salt Lake City, UT (US); Kent Monson, Pleasant Grove, UT (US); Kate Johnson, Sandy, UT (US); Pam Banning, Portland, OR (US); Shaun C. Shakib, Salt Lake City, UT (US); Elva Knight, Salt Lake City, UT (US); Edward M. Cassin, East Layton, UT (US)

Correspondence Address: WORKMAN NYDEGGER & SEELEY, 1000 EAGLE GATE TOWER, 60 EAST SOUTH TEMPLE, SALT LAKE CITY, UT, 84111, US

(21) Appl. No.: 09/755,969

(22) Filed: Jan. 5, 2001

(51) Int. Cl. G06F 17/60; G06F 7/00; G06F 17/30

(52) U.S. Cl. 705/3; 705/2; 707/4

(57) ABSTRACT

Systems and methods for mapping and matching laboratory results and tests. Laboratory results provided by legacy systems are not usually in a format that is compatible with LOINC, which defines laboratory results and tests using six attributes. Known LOINC codes are placed in a health data dictionary using relationship tables. At the health data dictionary, attributes corresponding to LOINC definitions are derived from the laboratory data provided by legacy systems and is placed in relationship tables that correspond to the relationship tables previously created and placed in the health data dictionary. The laboratory data from the legacy system is then compared with the standard data of the health data dictionary in order to match the legacy data to a standard value. This laboratory data from the legacy system, because it is matched, is thereby standardized and may be stored in a CPR. In this manner, data provided by legacy systems may be matched, mapped or translated using a health data dictionary, which contains a defined format even when the data from the legacy system is in a different format.

### BACKGROUND OF THE INVENTION

1. The Field of the Invention

The present invention relates to databases and to systems and methods for using databases as a dictionary. More particularly, the present invention relates to systems and methods for mapping and matching laboratory results using the dictionary database.

2. Description of Related Art

Computer based patient records (CPRs) are medical histories containing clinical data that can be stored and accessed electronically. Even though CPRs are accessible over computer systems, the medical community is still faced with the problem of processing and evaluating CPRs because the clinical data is often not normalized and different portions of the CPRs may have different data formats. Storing data in this manner can introduce significant inconsistencies and incompatibilities that significantly limit the usability of databases storing CPRs.

The difficulties associated with processing and evaluating CPRs begin with the organization and accessibility of the clinical data stored in the CPRs, which is often provided by a variety of different sources, such as laboratory systems, pharmaceutical systems, and hospital information systems. Because the clinical data comes from diverse sources, it is not surprising that the clinical data exists in different formats. International Classification of Diseases (ICD), Systematized Nomenclature of Medicine (SNOMED), Systemized Nomenclature of Pathology (SNOP), commercial systems, and other proprietary formats are examples of systems or formats used when creating and storing medical records such as CPRs. Clinical data or CPRs is often accessed by clinicians, administrators, and researchers, as well as for other reasons including regulatory requirements and statistical studies. Accessing clinical data that is not normalized and that is stored in different formats makes the clinical data less usable. For these reasons, accessing clinical data can be a lengthy and unfruitful process.

In order to integrate and normalize the clinical data that is received from various legacy systems and in various formats, a data dictionary is needed to help translate and normalize the clinical data. The data dictionary is effectively a medical database that should have a defined, controlled vocabulary that is able to identify and represent unique items or concepts. The data dictionary should also have a data structure that describes the relationships between concepts such that significant medical descriptions and relationships can be produced. A data dictionary meeting these requirements would be able to translate and normalize medical data regardless of the source of the data and the format of the data.

While the attributes of an ideal data dictionary are identifiable, creating such a dictionary is much more problematic. A significant challenge is developing a vocabulary that is capable of handling both syntactic and semantic constructions. This is particularly important with regard to medical data, which is often expressed in natural language rather than numbers.

An early attempt to develop a data dictionary was through the use of structured text, which is still in use in many systems. Structured text relies on a model that defines the order in which data will appear. For example, a model laboratory result can be expressed as: [patient], [test], [result name], [result value], and [units]. Structured text works relatively well for predictable data, but has significant disadvantages. A system using structured text to store clinical data does not perform any evaluation on the clinical data that is stored. As a result, misspellings and incorrect entries can easily occur. In addition, any application that is designed to effectively access the structured text must be aware of all possible data variations This limitation is extremely difficult to overcome because the dictionary storing the structured text as well as the applications accessing the structured text must be modified every time new information, such as lab tests or new drugs, are added to the structured text. Structured text systems also have difficulty dealing with complex data, such as microbiology reports, and are not able to handle a controlled and standardized vocabulary that can be shared with other providers.

Another vocabulary used in data dictionaries is ICD, which emphasizes semantics. ICD uses a three digit number for representing the general concept, followed by a two digit number that represents a specific concept. While the ICD vocabulary facilitates data storage and retrieval, ICD is not adequate for representing the clinical information that is stored in data dictionaries and ultimately, in CPRs. For example, ICD cannot effectively represent time, which is a key element in many medical events. ICD also has the disadvantage of using a single code or concept to represent multiple events. For example, the ICD code of 100.89, “Other Leptospiral Infection,” is used for at least three fevers and three infections. For this reason, ICD introduces ambiguity that should be avoided in the context of a data dictionary.

SNOMED is a coding system or nomenclature that attends to both semantics and syntax. In fact, SNOMED III is a complete vocabulary that enables practitioners to describe a great number of concepts found in CPRs. SNOMED can describe anatomical and temporal concepts as well as probabilities. In spite of these strengths, however, SNOMED does not provide a syntax that is capable of reflecting complex relationships. SNOMED is a substantially complete list of terms that does not clarify the relationships that exist among those terms.

The information that is ultimately stored in a CPR extends beyond the medical realm to include information related to areas such as demographics and insurance. This type of information presents problems similar to the problems presented by medical vocabularies because different systems use different representations for a single concept For example, the name of an insurance carrier can be represented in several different ways by different legacy systems. A properly designed data dictionary, therefore can assist the storage of patient related data by providing a vocabulary for other data in addition to medical data.

One of the problems faced by data dictionary is the inability to automatically interpret and interact with information provided by legacy systems. There are many different types of information that medical data dictionaries cannot currently overcome without human intervention. Laboratory results are particularly problematic because they present a group of related concepts or ideas. A laboratory result often includes a substance that was analyzed, a method of analysis, a time element and the like. In addition, laboratory results are provided in a format that is specific to the laboratory. The combination of these factors makes it extremely difficult to map and match laboratory results using a data dictionary.

Mapping and matching the laboratory data is necessary in order to normalize the laboratory results and in order to make the data that is ultimately stored in the CPR useful. Errors that are introduced in the mapping process results in ambiguous data. As a result, laboratory results are often manually mapped and matched before they are committed to a data repository. Automating the process of mapping and matching clinical data such as laboratory results is extremely difficult.

A direct consequence of having to manually map and match each laboratory result is increased expense and delay. The expense occurs because of the necessity to have human help in order to accurately map and match each laboratory result. The delay occurs because humans cannot function as quickly as computers. Typically, laboratories are producing many different laboratory results for many different people each day and there is a clear need for systems and methods for automating the process of mapping and matching laboratory results.

### SUMMARY OF THE INVENTION

These and other problems associated with related art are overcome by the present invention, which is directed toward automating the process of mapping and matching laboratory results using a health data dictionary. Specifically, the present invention relates to systems and methods for mapping laboratory results to Logical Observation Identifier Names and Codes (LOINC). LOINC defines laboratory results using six attributes and each unique combination of the six attributes constitutes a different and unique laboratory result that is given a unique LOINC code.

The inadequacies and shortcomings of previous vocabularies are substantially overcome by the 3M® Healthcare Data Dictionary (HDD). In the HDD, each concept or item is uniquely defined and the HDD is able to incorporate other vocabularies such as ICD and SNOMED into the definitions and descriptions of the unique concepts. In addition, the HDD is able to establish complex relationships between different concepts, which permits meaningful medical expressions to be conveyed. The HDD, in addition to providing a vocabulary for medical data, also provides a vocabulary for other types of data such as demographics, insurance data, pharmaceutical data, physical location data, and the like.

The HDD allows normalized and unambiguous data to be stored by accurately translating patient data regardless of the source and format of the patient data. The HDD also enables users to retrieve data in their own format. The HDD includes multiple concepts that define all potential data elements. If an unknown or new data element is present, it can be added to the HDD as needed.

The HDD, or more generally, a health data dictionary is a database that includes relationship tables to define the concepts stored in the health data dictionary. With regard to laboratory results, one embodiment of the health data dictionary incorporates LOINC, and existing LOINC codes are created in the HDD using these relationship tables. LOINC codes are expressed using the attributes of component/analyte, property, time, system/specimen, scale, and method, and these attributes are defined in the relationship tables of the HDD.

After the tables for the existing LOINC codes have been created, data can be requested from a legacy system. However, the data provided by the legacy system is typically in a format that is familiar to the legacy system instead of the LOINC format. The present invention derives LOINC attributes from the data submitted by the provider and compares the derived attributes to the attributes in the HDD tables. This process is often aided through the use of synonym tables that identify different ways that a particular attribute may be identified. For example, Metanephrine may be represented by a provider as Metaneph or 24H Metaneph. The synonym tables allow the attributes to be more readily identified.

The set of attribute relationships derived from the provider data is then compared to existing attribute relationships in the HDD in order to match the laboratory result. If a match is found in the HDD, then the laboratory result is stored in a data repository. This process also normalizes the data. If a match is not found, then the unmatched set of attribute relationships is examined and, if necessary, added to the HDD for use with future data. In this manner, the ability of the HDD to map and match laboratory results is continually increasing in both efficiency and depth. The modification of the HDD for an unmatched laboratory result may include, but is not limited to, a new LOINC entry, an alteration of an existing LOINC entry, an alteration of a synonym table, and the like.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary system that provides a suitable operating environment for the present invention;

FIG. 2 is a block diagram illustrating the concepts, rules, and knowledge base within a health data dictionary; and

FIG. 3 is a block diagram illustrating how data from legacy systems is translated by a health data dictionary and stored in a data repository.

### DETAILED DESCRIPTION OF THE INVENTION

The present invention relates to systems and methods for translating clinical data and more specifically to mapping and matching laboratory results. After the data has been mapped and matched, the data may be stored in a general data repository. The translation is accomplished using a health data dictionary (HDD). The HDD not only translates the data but also assists in the normalization of the data before the data is committed to the general repository. The HDD can also be used to retrieve data from the general repository such that the data can be presented in its original or other format.

As used herein, clinical, medical or patient data refers to data that is associated with a patient and can include, but is not limited to, pharmaceutical data, laboratory results, diagnoses, symptoms, insurance data, personal information, demographic data, and the like. Generally, clinical data generated by a legacy system is stored in a general repository, which may be on-site or off-site. The general repository can also be specific to a particular facility or source or used by multiple sources. Before the clinical data is stored in the general repository, it is transmitted through an interface engine to the HDD, where it is mapped, matched, and/or translated. Finally, the processed data is committed to the general repository. The HDD allows codes to be stored with the clinical data such that the clinical data can be consistently retrieved. The present invention therefore extends to both systems and methods for mapping, matching, and translating clinical data. The embodiments of the present invention may comprise a special purpose or general purpose computer including various computer hardware, as discussed in greater detail below.

Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

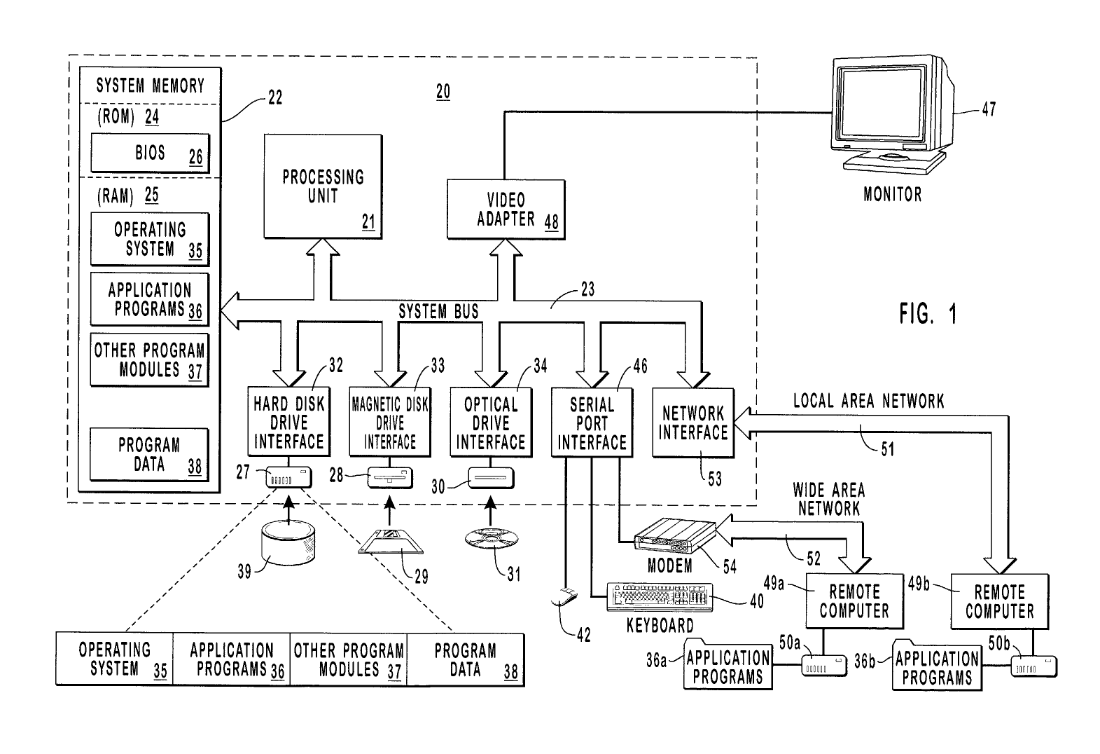

FIG. 1 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 1, an exemplary system for implementing the invention includes a general purpose computing device in the form of a conventional computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically include many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 may include a modem 54, a wireless link, or other means for establishing communications over the wide area network 52, such as the Internet. The modem 54, which may be internal or external, is connected to the system bus via the serial port interface 46. In a networked environment, program modules depicted relative to the computer 20, or portions thereof, may be stored in the remote memory storage device. It will be appreciated that the network connections shown are exemplary and other means of establishing communications over wide area network 52 may be used.

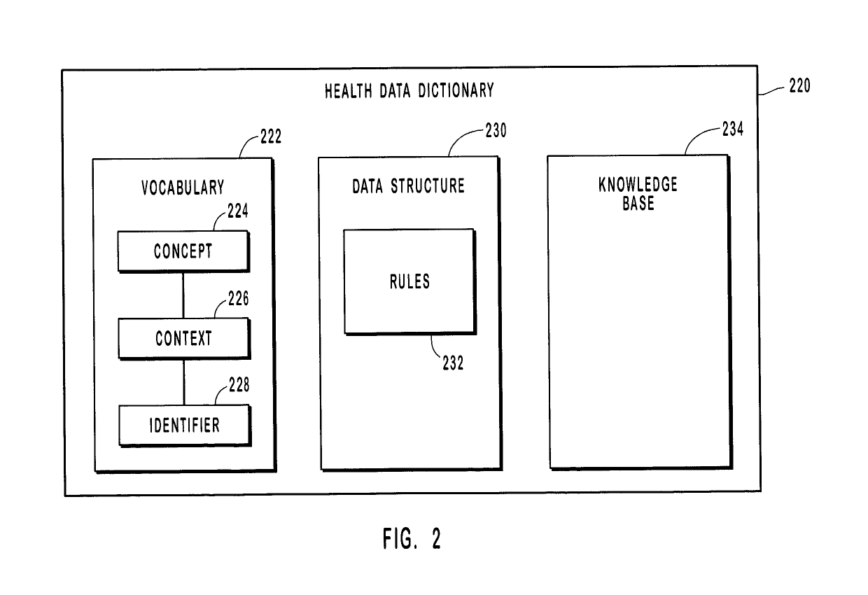

FIG. 2 is a block diagram that illustrates an exemplary health data dictionary (HDD). The HDD 220 describes clinical or medical data in all its possible forms, eliminates data ambiguity, and ensures that data is stored in an appropriate format. The HDD 220 is a database that is used to define or translate the clinical data in a computer based patient record (CPR). The HDD 220 ensures that patient data from multiple sources can be integrated and normalized into a form that is accessible by those sources. The HDD 220 integrates a controlled vocabulary, an information model that defines how medical concepts can be combined to produce medical descriptions, and a knowledge base that describes the complex relationships that may exist between the medical concepts. The vocabulary 222 is designed to identify and uniquely represent concepts. Each concept 224 described within a particular context 226 is assigned a unique identifier 228. For example, the term or concept of “discharge” can occur in several different contexts: A patient can be discharged from a hospital; a surgeon can send a discharge from a wound to a laboratory; a chart can reflect that a discharge from a patient's ears has been occurring for a certain length of time; or a discharge code can be assigned to a particular case. Another example is the concept represented by the term “cold.” Cold can refer to body temperature, a feeling, or an upper respiratory infection.

The ambiguity created by these types of terms can be quickly and easily resolved by a care provider or other person because the context is readily apparent to the care provider. It is much more difficult, however, for computers to resolve these types of problems. The HDD 220 overcomes this problem with the vocabulary 222. The vocabulary 222 includes a concept 224, which is a unique, identifiable item or idea. Using the previous example, “cold” can be a concept. In order to make the cold concept unique, it is often provided in a context 226. As used herein, the combination of context and concept is referred to generally as a concept. If cold refers to an upper respiratory infection, then the context may be, for example, a diagnosis. This type of combination of a concept 224 and a context 226 results in unique identifiable items or ideas and each is assigned an identifier 228. In the HDD 220, duplicate concepts or identifiers 228 are not allowed in order to maintain an accurate, controlled vocabulary 222. The HDD 220 is therefore capable of linking vague, ambiguous representations to precise definitions. The context 226 is often referred to as a domain. Examples of domains include, but are not limited to, insurances, diagnoses, symptoms, lab tests, lab results, and the like.

In essence, the vocabulary 222 links surface forms or representations of concepts as they occur in medical language to unique, unambiguous concepts. For example, the representation of “common cold” and the representation of “URI” can both be related to the cold concept that is defined to be an upper respiratory infections. The vocabulary 222 incorporates many different types of surface forms. For example, synonyms, homonyms, and eponyms are related to concepts in the HDD 220. Different representations of the same concept are related in the HDD 220. Thus, expressing a concept using either natural language or SNOMED will be connected to the same unique concept in the HDD 220. Common variants of a term including acronyms and misspellings are integrated into the vocabulary 222. Foreign language equivalents are included in the vocabulary 222 and specific contexts for certain terms are also reflected in the vocabulary. For instance, “dyspnea” may be a surface form for cardiologists while “shortness of breath” may be the preferred surface form for nursing station personnel.

The HDD 220 uses relationship tables to create these complex relationships. In one embodiment, the HDD 220 simply stores identifiers in the relationship tables, which are used to map or translate data as will be described in more detail below. The surface forms or representations are expressed in tables that effectively map surface forms to specific unique concepts. It is therefore possible for a surface form to be related to more than one concept. In this case, the context is useful in determining which concept is used as previously described.

The data structure 230 is a component of the HDD 220 that provides rules 232 to define how medical concepts are utilized. For example, the isolated concept of cold may be of little value. However, combining the cold concept with other concepts such as other symptoms, can result is a medical description. The concepts which represent symptoms can be combined to describe that a patient feels cold, nauseous, and feverish. In another example, the concepts of chest, x-ray and lung mass can be combined to describe that a chest x-ray shows a lung mass. The rules 232 ensure than meaningful medical descriptions are formed. In other words, concepts such as feverish cannot be combined with an x-ray because an x-ray cannot depict the feverish concept. The rules 232 can be altered as needed to ensure that accurate medical descriptions are obtained from the HDD 220.

The knowledge base 234 of the HDD 220 is used to describe the relationships that exist between the concepts in the HDD 220. For example, a lung mass bay be caused by lung cancer. In one embodiment of the HDD 220, the knowledge base 234 exists as related concept tables that link concepts together in defined relationships. The knowledge base 234 may use “is” and “has the components of” relationships to define the related concept tables. For example, the following table represents an exemplary portion of the knowledge base 234.

TABLE 1

| Concept (Context) | Relationship | Concept |
|---|---|---|
| Temperature | Is | Cold |
| | | Hot |
| | | Tepid |
| Illness | Has the components of | Symptoms |
| | | Vital signs |
| | | Diagnosis |

Other types of relationships, such as “is a,” “caused by,” “related to,” “relieved by,” and the like can all be expressed and represented in the knowledge base 234. More generally, the HDD 220 is a collection of relationship tables that define concepts, establish relationships, and provide essential information necessary to translate, map and match clinical data contained in CPRs stored in a data repository. When clinical data has been translated and he unique identifiers describing that data are identified, the unique identifiers are often stored in the data repository such that the process can be reversed.

In order to maintain the integrity of the HDD, each different legacy system, organization, facility, or entity maintains a local copy of the HDD. A master version of the HDD is maintained at a different location and the copy of the HDD can be updated as needed. If necessary, changes made to the copy of the HDD can be uploaded to the master version of the HDD if necessary. In certain circumstances, the local copy of the HDD can the alteration is not made to the master version in order to preserve the integrity of the master version. In addition, many local changes are entity-specific and would have no meaning to other entities. For that reason, these types of changes to the HDD are not propagated. In other words, entities maintain copies of the HDD in part because much of the information maintained by the HDD, such as physical location data, is specific to a user and does not need to be stored in the master version of the HDD. If a particular concept is not found in the HDD, an error message is sent to the master HDD. The error message is reviewed and a new entry may be created in the HDD, depending on the analysis of the error message. If a new entry is created, the local copy of the HDD is updated such that the event that generated the error message no longer occurs.

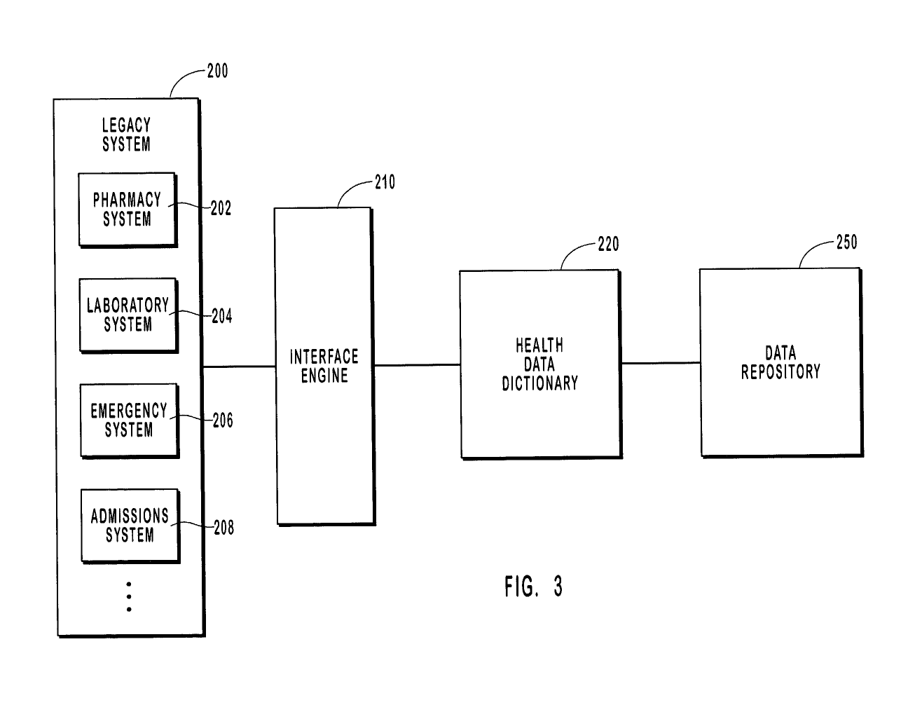

The formation of an extensive computer based patient record (CPR) can potentially involve many different health care providers. Each of these providers obtains different types of information from the patient whose clinical data is stored in the CPR. As previously described, the number of different care providers often causes problems with the CPR because the information gathered by those care providers is in different formats or vocabularies and is not normalized. FIG. 3 is a block diagram that illustrates an exemplary system that uses a health data dictionary to effectively create and store CPRs. The health data dictionary has the significant advantages of providing a data scheme that normalizes patient data and removes ambiguity, returns the patient data to care providers in the appropriate format, and describes medical data in all of its possible forms.

FIG. 3 illustrates a legacy system 200, which is representative of the sources of clinical data including facilities, enterprises, divisions within enterprises, and the like. Exemplary legacy systems include, but are not limited to, pharmacy system 202, laboratory system 204, emergency system 206, and admissions system 208. Each legacy system 200 is used to reflect patient data. The pharmacy system 202, for example, may reflect which drugs have been prescribed for a particular patient as well as the dosage. The laboratory system 204 may describe the results of tests that have been ordered for the patient. The emergency system 206 may reflect the symptoms of a patient as well as a possible diagnosis. The admissions system probably reflects patient data such as name, address, insurance carrier, and the like. In addition, the patient gathered by these legacy systems 200 may overlap in some instances. Other systems may also be used to gather patient information.

Each legacy system transmits data through an interface engine 210. In some instances, the interface engine 210 is not required because the legacy system is a direct client of the HDD. The interface engine 210 generates an interface code that is used when the HDD 220 processes the clinical data provided by the legacy system 200. For example, if the laboratory system 204 is sending data that identifies a patient's blood type from a blood test, then the interface code may be “blood type.” Note that while text is used in this discussion, the actual interface code is most likely a computer recognizable alphanumeric string. The HDD 220 receives the interface code and is aware that the interface engine 210 associated with the laboratory system 204 sent the clinical data. Based on this context, the HDD 220 is able to use the interface code to find the concept identifiers that represent blood type. In this situation, more than one concept may be needed to accurately reflect the clinical data. A separate concept identifier may be needed to identify the test performed by the laboratory, the actual blood type, and the like. These concept identifiers are then stored in the data repository 250 along with information that identifies the patient. In this manner, the data repository 250 contains a patient's CPR in a standard and normalized form that is consistent with other information stored in the data repository 250 for that patient from other clinical data sources. The data repository 250 therefore contains a complete history of medical events associated with a particular person in a form that allows for efficient use by multiple parties. If the test is retrieved from the data repository 250, the HDD 220 can reverse the process to determine that a blood test was performed as well as provide the results of the blood test in the appropriate format or vocabulary. The HDD 220 therefore serves to translate clinical data into a standard and normalized format. Note that the combination of the unique concepts provides a meaningful medical description.

Depending on the information received by the HDD 220, the mapping and matching operations can be quite complex. While the blood test example provides a general overview of the process, the following discussion will focus on the actual details of mapping or matching laboratory results at the HDD.

Logical Observation Identifier Names and Codes (LOINC) is an example of a standard for laboratory result names. In LOINC, laboratory results are named using to six attributes: components or analytes such as sodium or glucose; properties such as substance concentration or mass rate; time such as random or 24 hours; system or specimen or sample such as serum or urine; scale or precision such as quantitative or ordinal; and method such as electrophoresis or immune blot. Each combination of each attribute constitutes a unique laboratory result and is given a unique LOINC identifier. Each unique combination is also stored in the HDD using a relationship table to identify the attributes.

As previously discussed, laboratory results provided by legacy systems are not usually in a form that translates quickly and easily to LOINC definitions and significant human and machine resources are required in order to ensure that laboratory results ultimately stored in the data repository are normalized, accurate and consistent. Normalization of the data implies that each laboratory result is translated to an appropriate form or format using the HDD.

In the following tables, text is used as entries in the tables for clarity. However, identifiers are used in practice. The following table I is an example of LOINC code and its six attributes.

TABLE I

| | | | | | | | |
|---|---|---|---|---|---|---|---|
| LOINC | | Component/ | | | System/ | | |
| CODE | LOINC Name | Analyte | Property | Time | Specimen | Scale | Method |

| | | | | | | |
|---|---|---|---|---|---|---|
| 2159-2 | CREATININE:MCNC: | Creatinine | Mass | Point | Amniotic | Quantitative |
| | PT:AMN:QN | | Concentration | In | Fluid | |
| | | | | Time | | |

Each LOINC code is a unique combination of six attributes and as a result, each LOINC code can have a unique set of relationships, one to each attribute. The following table provides a relationship for the above mentioned LOINC code.

TABLE II

| Concept A | Relationship | Concept B |
|---|---|---|
| LOINC 2159-2 | Has Component | Creatine |
| LOINC 2159-2 | Has Property | Mass Concentration |
| LOINC 2159-2 | Has Time | Point in Time |
| LOINC 2159-2 | Has System | Amniotic Fluid |
| LOINC 2159-2 | Has Scale | Quantitative |
| LOINC 2159-2 | Has Method | Null Method |

Also, each independent value of an attribute is a concept and is placed in the HDD. The following table illustrates how these attributes may be placed in the HDD. Text is used for clarity, but an identifier is actually stored in the HDD.

TABLE III

| Concept A | | Relationship | Concept B |
|---|---|---|---|
| | Creatinine | Is A | Component |
| | Metanephrine | Is A | Component |
| | Creatine Kinase | Is A | Component |
| | CK MB | Is A | Component |
| | Hepatitis A IgM | Is A | Component |
| | Mass Concentration | Is A | Property |
| | Mass Rate | Is A | Property |
| | Catalytic Concentration | Is A | Property |
| | Arbitrary Concentration | Is A | Property |
| | Point in Time | Is A | Time |
| | 24 Hour | Is A | Time |
| | Amniotic Fluid | Is A | System |
| | Urine | Is A | System |
| | Serum | Is A | System |
| | Quantitative | Is A | Scale |
| | Ordinal | Is A | Scale |
| | Null Method | Is A | Method |
| | Electrophoresis | Is A | Method |

Tables I, II, and III are example of how existing LOINC codes are represented in the HDD and how relationship tables are established for existing LOINC codes and are examples of steps for creating standard sets of relationships in the HDD. After this information is prepared and stored in the HDD, the HDD is prepared to receive laboratory data. As previously mentioned, this data is usually not in a LOINC format, but is likely in a format familiar to the submitting laboratory. The following table represents an example of data received from a legacy system that will be mapped to LOINC codes using the HDD.

TABLE IV

| Result | Result | | Data | Data Value | | | |
|---|---|---|---|---|---|---|---|
| Code | Name | Specimen | Type | Examples | Unit | Timing | Method |
| 1000 | Creatinine | Amniotic | NUM | | MG/DL | | |
| | | FL | | | | | |
| 2000 | 24H | Urine | NUM | | MG/24H | | |
| | Metaneph | | | | | | |
| 3000 | CK | Serum | NUM | | U/L | | |
| 4000 | CK.MB | Serum | % | | | | Electrophoresis |
| 5000 | Havab | Serum | Text | Positive/Negative | | | |
| | Igm | | | | | | |

Mapping the data illustrated in Table IV to LOINC attributes requires that attribute information first be derived from the data. The attributes are derived in this example using a set of synonym tables in combination with parsing and logic rules. The following tables are synonym tables used to derive attribute information from the submitted data.

TABLE V
Synonyms for the Component Attribute

| Concept ID | Concept Name | Synonym |
|---|---|---|
| 11 | Metanephrine | Metaneph |
| 11 | Metanephrine | 24H Metaheph |
| 12 | Creatinine Kinase | CK |
| 12 | Creatinine Kinase | CPK |
| 12 | Creatinine Kinase | CK Total |

TABLE VI
Synonyms for the System Attribute

| Concept ID | Concept Name | Synonym |
|---|---|---|
| 22 | Urine | U |
| 22 | Urine | UR |
| 22 | Urine | 24 U |
| 22 | Urine | 24 UR |
| 6 | Amniotic Fluid | AMN FL |
| 6 | Amniotic Fluid | Amniotic F1 |
| 6 | Amniotic Fluid | AMN |

In this example, the data in the “result name” and “specimen” columns of Table IV are compared to the synonyms found in Tables V and VI. This comparison allows the concept that correctly identifies those attributes to be identified. The synonym tables can be created from a variety of different sources, including but not limited to, textbooks, laboratory manuals, user guides, other databases, and the like. The synonym tables can be augmented manually in some instances. For example, when submitted data does not result in a match, the data may be manually matched to a LOINC code and a HDD concept. If the submitted data does not match existing codes in the HDD then a new entry is created in the HDD if the submitted data is valid. In this manner, the effectiveness of automatically matching laboratory results continually improves.

As noted in Table IV, a time element is often included in either the result name or the specimen. In this example, the time element is ignored when using the synonym tables to identify the correct concept. However, a timing element can be used when determining the time attribute of the submitted data.

The following table is used to demonstrate how the property attribute is derived from the submitted data.

TABLE VII
Deriving the Property Attribute

| Concept ID | Concept Name | Property |
|---|---|---|
| 28 | MG/DL | Mass Concentration |
| 29 | G/L | Mass Concentration |
| 30 | MG/24H | Mass Rate |
| 31 | NG/MIN | Mass Rate |

From Table IV, the data type of the columns identifying the result name, data type, and unit columns are used to derive the property and scale attributes. For example, if the data type is a number, then the scale attribute is quantitative. As shown in Table VII, the unit of the laboratory result points to its property. As previously mentioned, unknown units or other data will be manually matched and added to the relationship tables of the HDD for future mapping. In some instances, columns of data shown in Table IV are checked for data that normally appears in other columns. Units, for example, are often placed in the data type column. Analyzing the submitted laboratory data as described herein is an example of a step for deriving sets of relationships that can be compared to the standard sets of relationships stored in the HDD.

Using these tables as described above results in the following table VIII that shows the end result of the manipulation of the data found in Table IV, which was submitted for matching by a legacy system.

TABLE VIII

| Result | Result | Component/ | | | System | | |
|---|---|---|---|---|---|---|---|
| Code | Name | Analyte | Property | Time | Specimen | Scale | Method |
| 1000 | Creatinine | Creatine | Mass | Point | Amniotic | Quantitative | Null Method |
| | | | Concentration | in | Fluid | | |
| | | | | Time | | | |
| 2000 | 24H | Metanephrine | Mass Rate | 24 | Urine | Quantitative | Null Method |
| | Metaneph | | | Hour | | | |
| 3000 | CK | Creatine | Catalytic | Point | Serum | Quantitative | Null Method |
| | | Kinase | Concentration | in | | | |
| | | | | Time | | | |
| 4000 | CK.MB | CK MB | Catalytic | Point | Serum | Quantitative | Electrophoresis |
| | | | Concentration | in | | | |
| | | | | Time | | | |
| 5000 | Havab | Hepatitis A | Arbitrary | Point | Serum | Ordinal | Null Method |
| | IGM | IgM | Concentration | in | | | |
| | | | | Time | | | |

After the submitted data has been manipulated in this manner, an attribute relationship set can be generated for each specific result code. The following Table IX illustrates the attribute relationship set for the result code 1000 from Table VIII.

TABLE IX

| Concept A | Relationship | Concept B |
|---|---|---|
| Result Code 1000 | Has Component | Creatine |
| Result Code 1000 | Has Property | Mass Concentration |
| Result Code 1000 | Has Time | Point in Time |
| Result Code 1000 | Has System | Amniotic Fluid |
| Result Code 1000 | Has Scale | Quantitative |
| Result Code 1000 | Has Method | Null Method |

Table IX may be easily compared with Table II, which is the LOINC definition. When a match is found, the clinical data submitted by the legacy system is effectively mapped, matched and normalized. The concept identifiers for this result is stored in the general repository with the rest of the CPR. When access to the information is needed, the HDD can be consulted to determine what medical information corresponds to the stored identifiers.

Because the matching and mapping process is substantially automated, another table containing matching rules can be created to ensure that the data is correctly matched. For example, mapping frequency information can be kept in this table that may be used to suggest the most likely match for a given laboratory result. These matching rules also help prevent unintentional inconsistencies.

In some instances, an exact match will not be found. In these instances, the synonym tables can be used to find a match for each individual attribute of the submitted data and a new laboratory result and set of attributes is added to the HDD for future mapping. Later, a LOINC code can be assigned to this laboratory result. This procedure allows new laboratory results to be added automatically.

The present invention permits laboratory results to be matched and loaded into the HDD. Laboratory results can be matched or added one at a time or in batches. New concepts representing laboratory results or associated with laboratory results can be created in the HDD. Also, rules are also included to ensure that conflict and redundancy are substantially reduced or eliminated. The present invention allows existing concepts to be searched for both tests and results, adds concepts to the HDD while checking for completeness and redundancy, implements formal definitions to the HDD and accounts for both complete and partial matches with existing concepts. The systems and methods described herein significantly reduce the time required to match laboratory tests and results by automating the matching process while ensuring accuracy and completeness.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by U.S. Letters Patent is:

1. In a system including a legacy system producing clinical data for storage in a data repository, the clinical data having a format specific to the legacy system, a method for matching the clinical data to a standard of the clinical data before storing the clinical data in the data repository, the method comprising:
an act of receiving the clinical data from the legacy system at a health data dictionary;
an act of translating the clinical data by the health data dictionary such that the clinical data has a new format that is compatible with the standard;
an act of comparing the new format of the clinical data with the standard of the clinical data; and
when a match is found between the new format of the clinical data and the standard of the clinical data, an act of identifying one or more concept identifiers for the clinical data.

2. A method as defined in claim 1, wherein the act of receiving the clinical data further comprises an act of receiving the clinical data through an interface engine, wherein the interface engine provides an interface code.

3. A method as defined in claim 2, wherein the act of translating the clinical data further comprises an act of accessing the health data dictionary using the interface code.

4. A method as defined in claim 1, wherein the act of translating the clinical data further comprises an act of identifying attributes of the clinical data.

5. A method as defined in claim 4, wherein the act of identifying attributes further comprises an act of parsing the clinical data.

6. A method as defined in claim 4, further comprising an act of identifying attributes from the clinical data, wherein the attributes correspond to attributes of the standard.

7. A method as defined in claim 4, further comprising an act of using synonym tables to identify the attributes of the clinical data, wherein the synonym tables list equivalent expressions of the attributes.

8. A method as defined in claim 4, further comprising an act of using relationship tables to define the clinical data.

9. A method as defined in claim 1, further comprising an act of storing the standard format of the clinical data in the data repository, wherein the one or more concept identifiers are stored with the clinical data.

10. A method as defined in claim 9, further comprising an act of retrieving the clinical data from the data repository.

11. A method as defined in claim 1, wherein the clinical data is laboratory results and wherein the standard format is Logical Observation Identifier Names and Codes.

12. A computer program product having computer executable instructions for performing the acts recited in claim 1.

13. In a system including a legacy system providing clinical data including laboratory results to be stored in a data repository, wherein the laboratory results are in a format specific to the legacy system, a method for matching the clinical data including the laboratory results to a health data dictionary, the method comprising:
an act of loading standard laboratory results into the health data dictionary, wherein each standard laboratory result is associated with a unique concept identifier;
an act of creating standard relationship sets for each unique standard laboratory result, wherein the relationship sets establish relationships for attributes of each unique standard laboratory result;
an act of creating synonym tables for the attributes of the unique standard laboratory results;
an act of receiving the laboratory results at the health data dictionary;
an act of deriving attributes from the laboratory results using the synonym tables;
an act of generating a legacy relationship set for the laboratory results from the derived attributes; and
comparing the legacy relationship set with the standard relationship sets.

14. A method as defined in claim 13, wherein the standard relationship sets identify attributes of each unique standard laboratory result.

15. A method as defined in claim 13, further comprising an act of determining if a new standard laboratory result should be added to the health data dictionary if an exact match is not found with the legacy laboratory result.

16. A method as defined in claim 13, further comprising an act, of comparing respective attributes of the legacy relationship table with the standard relationship tables.

17. A method as defined in claim 13, further comprising an act of preventing matching inconsistencies using rules.

18. A method as defined in claim 17, wherein the rules includes at least one of: frequency mapping; and suggesting a most likely match.

19. A method as defined in claim 13, wherein the attributes include a component attribute, a property attribute, a time attribute, a system attribute, a scale attribute, and a method attribute.

20. A method as defined in claim 13, further comprising an act of storing a matched laboratory result in the data repository, wherein the match laboratory result is normalized.

21. A method as defined in claim 13, further comprising an act of manually matching laboratory results that do not match the standard laboratory results.

22. A computer program product having computer executable instructions for performing the acts recited in claim 12.

23. In a system including a legacy transmitting legacy clinical information to a health data dictionary, a method for translating the clinical information to match a standard clinical information, the method comprising:
a step for creating standard sets of relationships for the standard clinical information in the health data dictionary;
a step for deriving legacy sets of relationships for the legacy clinical information; and
a step for comparing the legacy sets of relationships with the standard sets of relationships to identify an exact match for the legacy clinical information.

24. A method as defined in claim 23, wherein the step for creating standard sets of relationship further comprises a step for creating unique identifiers for each different code in the standard clinical information.

25. A method as defined in claim 24, wherein the step for creating standard sets of relationships further comprises:
a step for creating code relationship tables for each code, wherein the code relationship tables identify attributes of the standard clinical data; and
a step for creating attribute relationship tables for each code, wherein the attribute relationship tables identify independent values of the attributes of the standard clinical data.

26. A method as defined in claim 25, wherein the step of deriving legacy sets of relationships further comprises a step for identifying independent values of the attributes using synonym tables, wherein the synonym tables contain synonyms for independent values.

27. A method as defined in claim 26, further comprising a step for entering the derived attributes in the legacy sets of relationships.

28. A method as defined in claim 23, further comprising a step for adding a new standard sets of relationships for legacy sets of relationships that do not match standard sets of relationships.

29. A method as defined in claim 23, further comprising a step for suggesting a match when the legacy sets of relationships partially match the standard sets of relationships.

30. A method as defined in claim 23, wherein the standard sets of relationships comply with Logical Observation Identifier Names and Codes.

31. A computer program product having computer executable instructions for performing the steps recited in claim 23.
